(19) United States
(12) Patent Application Publication
(10) Pub. No.: US 2006/0284427 A1
(43) Pub. Date: Dec. 21, 2006

(54) Device for verification of locking or unlocking a lock that immobilizes a cover in and closing a frame

(75) Inventor: Gerald Borycki, Creil (FR)

Correspondence Address: LEYDIG VOIT & MAYER, LTD, 700 THIRTEENTH ST. NW, SUITE 300, WASHINGTON, DC, 20005-3960, US

(73) Assignee: NORINCO, Saint Crepin Ibouvillers (FR)

(21) Appl. No.: 11/452,432

(22) Filed: Jun. 14, 2006

(30) Foreign Application Priority Data
Jun. 15, 2005 (FR) 05 06 068

(51) Int. Cl. E05C 3/02

(52) U.S. Cl. 292/240

(57) ABSTRACT

The present invention relates to a device for verification of the position of locking or unlocking of a lock making it possible to immobilize in a frame a lid closing this frame.

The device is characterized by the fact that it has arm (10) kinematically connected to bolt (7) of lock (3) so as to move between two extreme positions corresponding respectively to the positions of locking and unlocking of bolt (7) and some means (11, 12) for detection of each of the extreme positions of arm (10) making it possible to provide an information signal depending on whether bolt (7) of lock (3) occupies its position of locking or unlocking of lid (1). The invention can be applied in the domain of roadway equipment.

The present invention relates to a device for verifying the position of locking or unlocking of a lock enabling one to immobilize in a frame a lid or cover for closing this frame.

It applies particularly but in a non-limiting manner to a manhole, the frame of which is connected to the road and the lid is applied on the frame so as to occupy a position for closing of this frame in which the lid can be locked by a lock connected to the lid and having a bolt that can be maneuvered by a key introduced through an opening produced in the lid for access to the lock in order to cooperate with a keeper of the frame, in such a way as to bring the bolt to its position for locking or unlocking of the lid with respect to the frame.

There is a known device enabling one to verify from a distance, for example, through a remote monitoring center, whether the frame is closed or not closed by the lid. More precisely, this device has a sensor, for example, of the magnetic, inductive or capacitive type, connected to the frame facing the inner side of the lid and that is connected by an electric cable to the remote monitoring center. Once an operator has unlocked the lock using the key, the removal of the lid from its support frame is detected by the sensor that transmits to the remote monitoring center an electrical signal indicating the open status of the frame, and when the lid is put back on the frame in order to close it, the sensor transmits to the remote monitoring center a signal indicating that the lid is occupying its position for closing of the frame.

However, this known device does not make it possible to indicate to the remote monitoring center that the lid has been correctly locked with respect to its frame once it is put on the frame, which then exposes the manhole to risks of vandalism in case the operator has neglected to lock the lid to the frame.

The present invention aims to eliminate the above disadvantage of the known devices by offering a device for verification of the position of locking or unlocking of a lock enabling one to immobilize in a frame a lid or cover for closing of this frame, the lock being connected to the lid and having a bolt that can be maneuvered by a key introduced through an opening for access to the lock produced in the lid, in order to cooperate with a matching keeper of the frame in such a way as to bring the bolt to its position of locking or unlocking of lid (1) with respect to the frame, and that is characterized by the fact that it has some means for detection of each of the two extreme positions of locking and unlocking of the bolt and making it possible to provide an information signal depending on whether the bolt of the lock occupies its position of locking or unlocking of the lid.

According to a first embodiment, the device moreover has an arm kinematically connected to the bolt of the lock so as to move between two extreme positions of locking and unlocking of the bolt

The mobile arm is connected perpendicularly to a shaft carrying the bolt of the lock and mounted so as to pivot in the lid in such a way as to allow the arm to pivot below the lid essentially in a plane perpendicular to the lid between its two extreme angular positions, and the detection means include two sensors connected to the frame at different sites of this frame, with the free end of the pivoting arm facing one or the other of the two sensors depending on whether it occupies its extreme position of locking or unlocking of the bolt, so that the sensor facing the end of the arm provides the signal corresponding to the locking or unlocking of the bolt.

According to a second embodiment, the bolt of the lock is connected to a shaft mounted so as to pivot in the lid, and its free end is formed by a curved wall over an angle of approximately 180°, and the detection means include two sensors connected to the frame at different sites of the frame, with one or the other of the free ends of the end wall of the bolt facing one or the other of the two sensors depending on whether the bolt occupies its extreme position of locking or unlocking, so that the sensor facing the corresponding end of the wall of the bolt provides the signal corresponding to the locking or unlocking of the bolt.

The detection means also make it possible to provide an information signal indicating that the lid is removed from its frame after the bolt has occupied its position of unlocking.

Each sensor is a proximity sensor of the magnetic, inductive, capacitive, photoelectric type or similar, or a contact sensor.

According to the first embodiment, the sensors are housed in a cavity formed in one of the lateral walls of the frame containing the keeper and are arranged at the same level parallel to the upper edge of this wall below this edge.

According to the second embodiment, the sensors are housed in a cavity formed in one of the lateral walls of the frame containing the keeper and are arranged one above the other being offset longitudinally with respect to the lateral wall.

The key selectively adopts, with respect to the opening of the lid, a position of locking of the lid to the frame in which the key can be freely removed from the lid and a position of unlocking of the lid in which the key is held captive in the opening of the lid.

Advantageously, the detection means are connected to a remote monitoring center making it possible to verify the status of these detection means.

The invention will be better understood and other aims, characteristics, details and advantages of it will appear more clearly from the following explanatory description in reference to the appended drawings given only by way of example, illustrating an embodiment of the invention and in which:

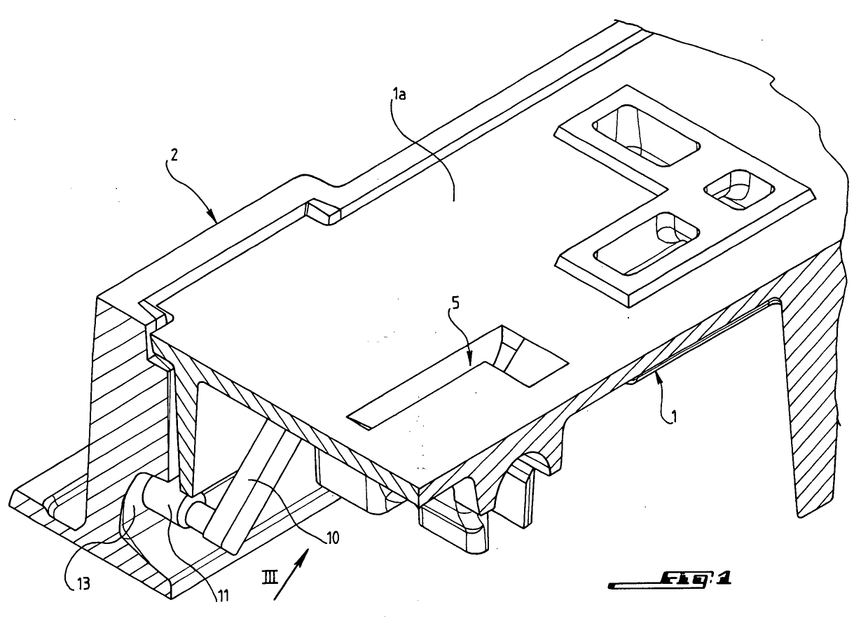

FIG. 1 is a partial view in perspective of a manhole with a frame and a closing lid, equipped with a device for verification of locking or unlocking of the lid according to a first embodiment of the invention;

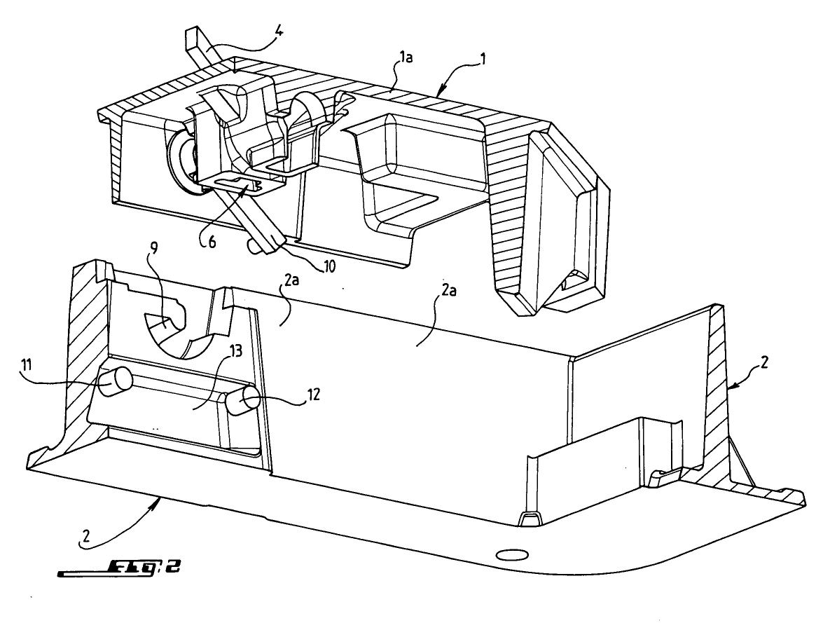

FIG. 2 is a partial view in perspective representing the manhole of FIG. 1 whose lid is separated from its support frame;

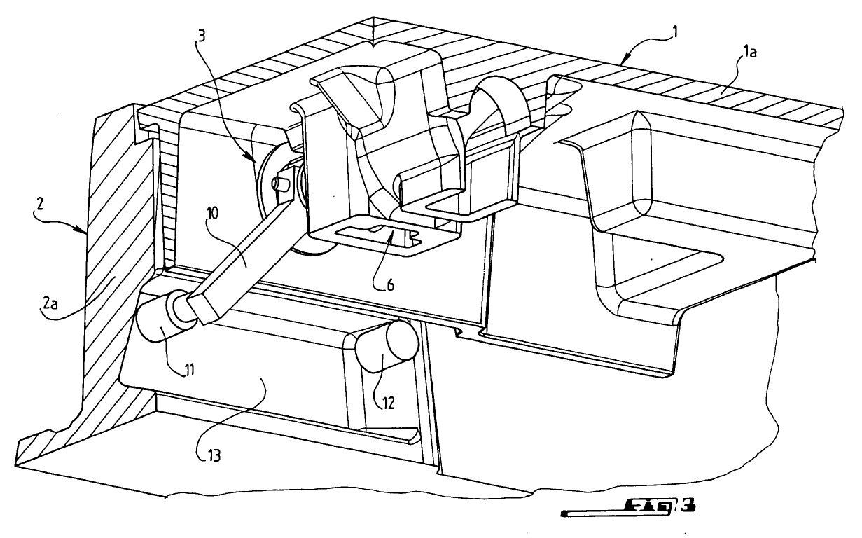

FIG. 3 is a bottom view in perspective according to arrow III of FIG. 1;

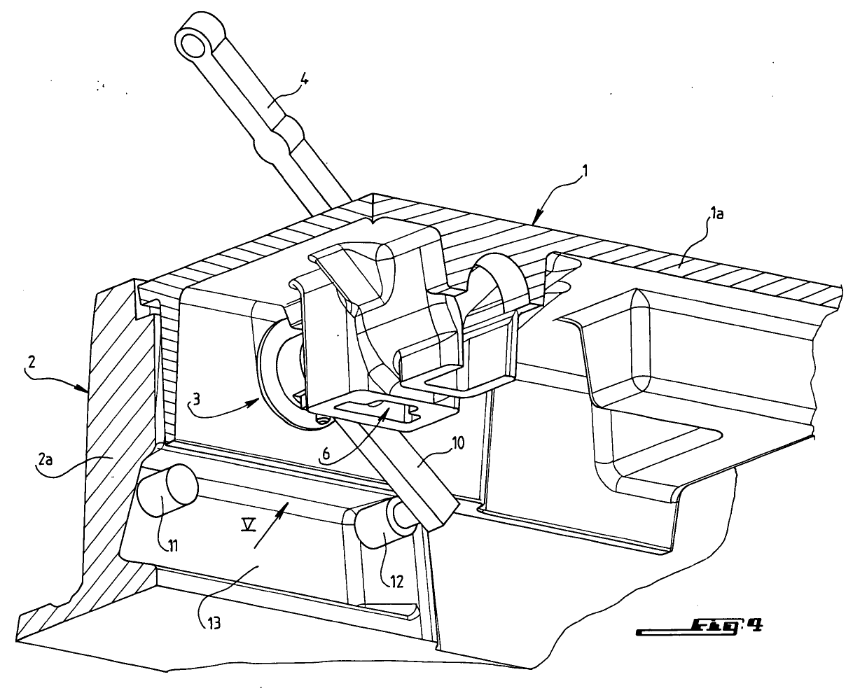

FIG. 4 is a view in perspective similar to that of FIG. 3 and representing the verification device in another position;

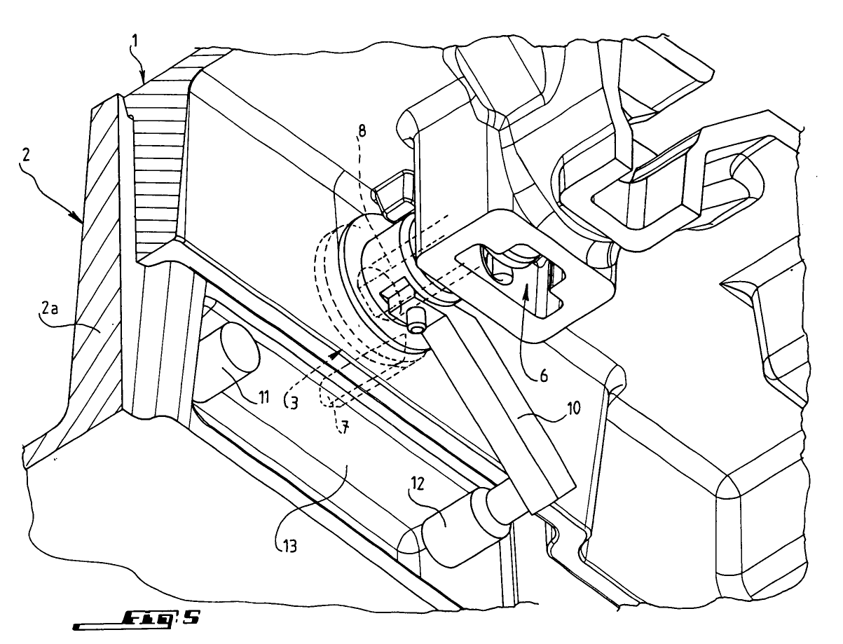

FIG. 5 is a bottom view in perspective according to arrow V of FIG. 4;

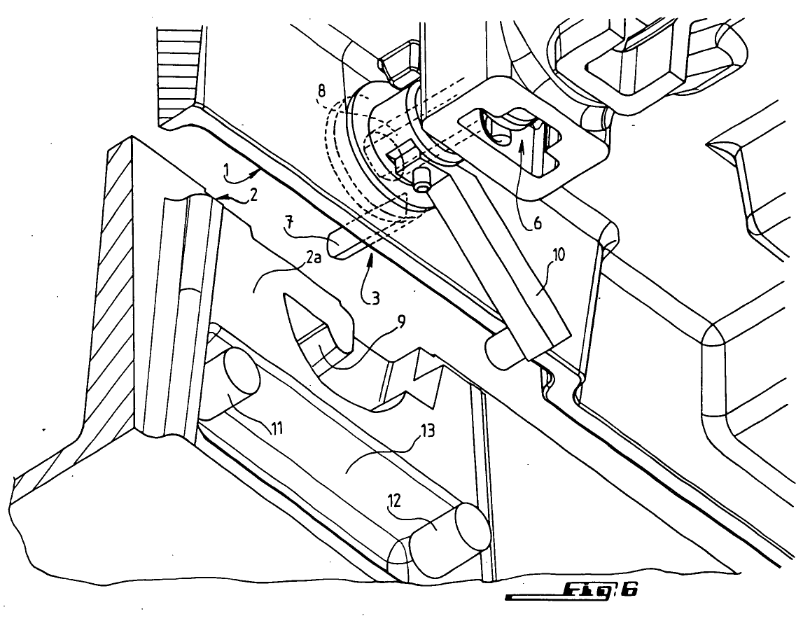

FIG. 6 is a bottom view in perspective similar to that of FIG. 5 and representing the lid removed from its support frame;

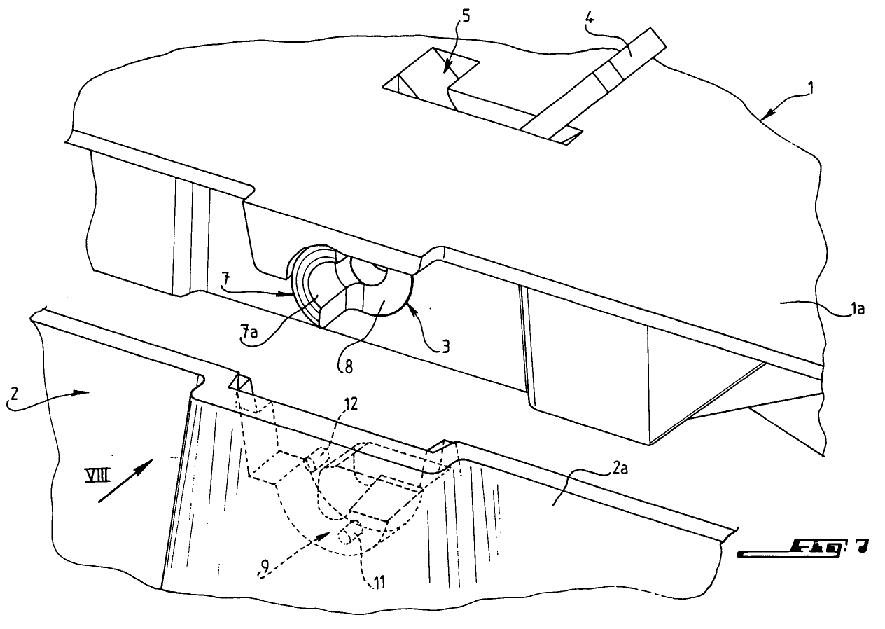

FIG. 7 is a partial view in perspective of an assembly with a lid and support frame separated from one another, and which is equipped with a device for verification of locking or unlocking of the lid according to a second embodiment of the invention;

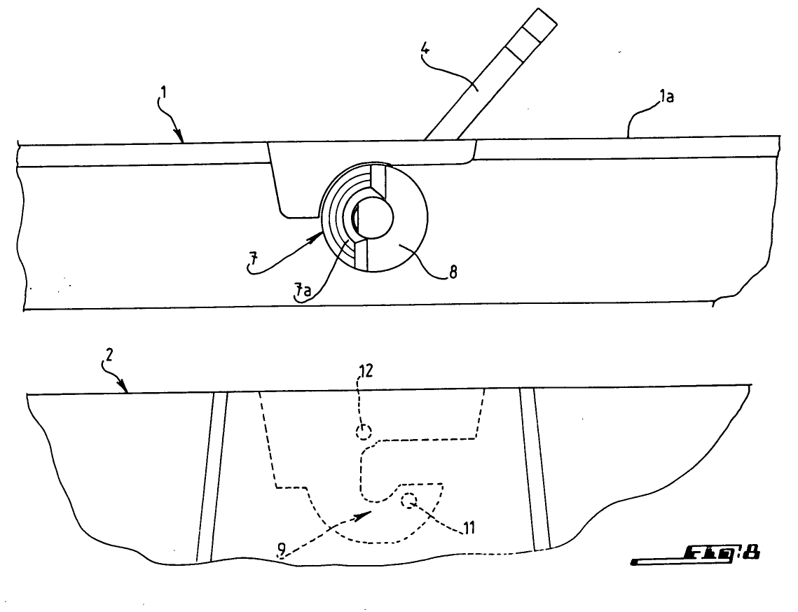

FIG. 8 is a side view according to arrow VIII of FIG. 7;

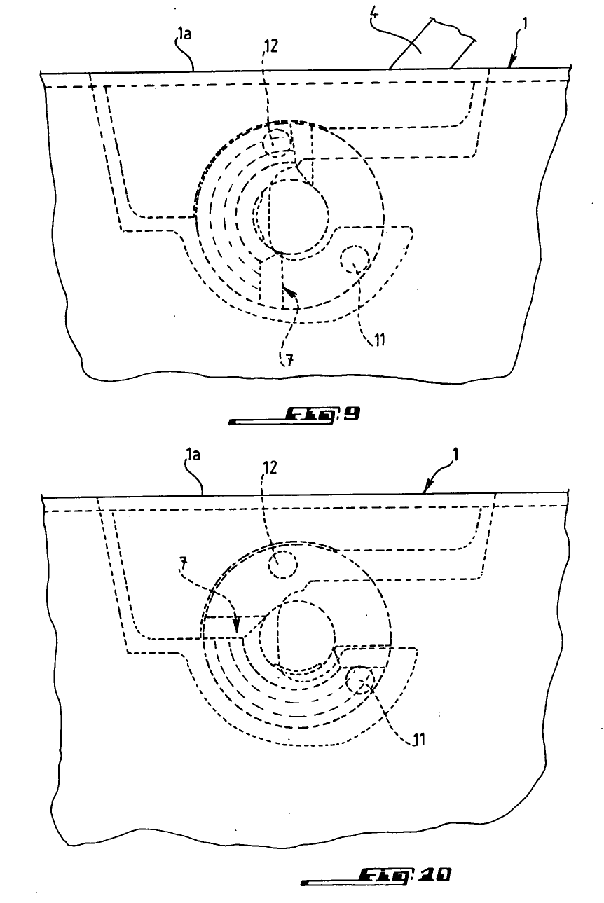

FIG. 9 is a side view similar to that of FIG. 8 with the lid placed on the frame and not locked to the latter; and

FIG. 10 is a side view as in FIG. 9 with the lid locked to the frame.

In the figures, reference 1 designates a lid or cover represented partially, allowing one to close frame or casing 2, also partially represented, and together constituting, for example, a manhole in which frame 2 is buried in the road.

Lid 1 can be locked in position of closing of frame 2, resting on the latter by lock 3 connected to lid 1.

Lock 3 can be operated by key 4 introduced through access opening 5 formed in flat upper wall 1a of lid 1, with opening 5 opening, on one hand, towards the exterior of this lid, and on the other hand, into cavity 6 in which lock 3 to a large extent is mounted.

Lock 3 as well as key 4 can, for example, be of the type to which European Patent No. 1 105 583 in the name of the Applicant relates.

Thus, lock 3 essentially has bolt 7 connected to one end of shaft 8 mounted so as to pivot in cover 1 and that can be maneuvered by key 4 when it is introduced into L-shaped opening 5. As in the above-mentioned European patent, key 4 can have a tube, not represented, extending perpendicularly to the end of key 4, which can be engaged in opening 5 and which has two opposite external projections ensuring the guiding of the tube towards shaft 8 for moving bolt 7, this shaft having an axial groove that cooperates with an axial internal rib of tube 7 in order to rotate the shaft 8 and bolt 7 assembly.

Frame 2 has, produced in one of its lateral walls 2a, notch 9 forming a keeper in which the bolt can be engaged in order to lock lid 1 to frame 2 in its closing position.

Key 4 selectively adopts, with respect to opening 5 of lid 1, a position of locking of this lid to frame 2 in which key 4 can be freely removed from lid 1 and a position of locking of the lid in which the key is held captive in opening 5 of this lid.

According to the invention, the manhole is provided with a device making it possible to verify the position of locking or unlocking of lock 3.

This device has rigid arm 10 of which one end is connected to sleeve 11 rotationally connected to shaft 8 of bolt 7 in such a way as to allow arm 10 to move by pivoting concomitantly with shaft 8 between two extreme positions represented in particular in FIGS. 3 and 4 corresponding to the positions of locking and unlocking of lock 3, that is to say to the positions of engagement of bolt 7 in keeper 9 and of disengagement of the bolt from this keeper.

Arm 10 extends perpendicularly to shaft 8 below lid 1, and it swings in a plane essentially perpendicular to the plane of upper wall 1a of lid 1.

The verification device moreover includes two sensors 11, 12 connected to frame 2, preferably housed in cavity 13 produced in lateral wall 2a below keeper 9 while being separated from one another by a determined distance along an axis essentially parallel to the exterior edge of lateral wall 2a of this frame and situated below this edge.

The distance separating sensors 11 and 12 and their location in cavity 13 of frame 2 are such that the free end of the arm faces one or the other of these two sensors so that they provide as output an electrical signal indicating that lock 3 is occupying its position of locking of lid 1 to frame 2 or its position of unlocking of lid 1 from this frame.

Thus, sensor 11 is capable of providing the electrical signal representative of the position of locking of lock 3, while sensor 12 is capable of providing the electrical signal representative of the unlocking of this lock.

The two sensors 11, 12 are connected in particular by sunken electrical cables to a remote monitoring center, not represented, making it possible to verify at a distance the status of each of these sensors. Thus, as an example, the remote monitoring center can display on an instrument panel, using an indicator light that illuminates red, the status of lock 3 in position of locking of lid 1 to frame 2 when the end of arm 10 is facing sensor 11, and using another indicator light that illuminates green, the unlocked status of this lock when the free end of arm 10 is facing sensor 12.

Each sensor 11, 12 can be a proximity sensor of the magnetic, inductive, capacitive, photoelectric type or similar, or a contact sensor.

The functioning of the verification device of the invention already emerges from the description given above and will now be explained.

In position of closing of frame 2 by lid 1 represented in FIGS. 1 and 3, the lock occupies its position of locking of lid 1 to this frame, in which the end of arm 10 faces sensor 11, which provides the remote monitoring center with an electrical signal representative of the locked status of lock 3.

When key 4 is introduced into opening 5 and maneuvered in the direction moving bolt 7 out of the keeper to its unlocking position, arm 10 is swung from its position represented in FIG. 1 to its position represented in FIGS. 4 and 5 in which arm 10 faces sensor 12, which provides the remote monitoring center with the electrical signal indicating that lock 3 is occupying its unlocking position in which key 4 is held captive by opening 5 of lid 1.

When lid 1 is removed from frame 2 as represented in FIGS. 2 and 6 in order to access the opening of the manhole, once the lock is in its unlocking position of course, the free end of arm 10 is completely disengaged from sensor 12, which then provides an electrical signal reflecting this status, making it possible to indicate to the remote monitoring center that lid 1 is removed from its frame 2.

When lid 1 is put back on frame 2, the free end of arm 10 faces sensor 12, which provides the remote monitoring center with information according to which lid 1 is in its position of closing of frame 2 and lock 3 occupies its unlocking position.

When key 4 is maneuvered in order to bring the lock to its locking position, and consequently, to bring bolt 7 into keeper 9, the free end of arm 10 faces the sensor, which provides the remote monitoring center with the information according to which lid 1 is indeed locked to frame 2.

It should be noted that the remote monitoring center can be adapted so as to provide an alert signal at the end of a determined period of time in case lid 1 has been placed on frame 2 without maneuvering of key 4 to bring the lock to its locking position, for example, after forgetfulness on the part of the operator in performing this operation of locking lid 1 to frame 2. This alert signal could be used to enable the remote monitoring center to inform the operator of this situation, for example, by calling him on his portable telephone.

According to the second embodiment represented in FIGS. 7 to 10, it is bolt 7 of lock 3 that is used in combination with sensors 11, 12 in order to provide information according to which lid 1 is locked or not locked to its support frame 2.

To this effect, bolt 7 is connected to shaft 8 of lock 3 mounted so as to pivot in lid 1 parallel to its upper flat surface 1a, and its free end is formed by curved wall 7a extending over an angle of approximately 180°, that is to say that wall 7a constitutes a cylindrical sector coaxial with shaft 8.

The two sensors 11, 12 are connected to the inner side of lateral wall 2a of frame 2 delimiting the bottom of keeper 9 and are arranged one above the other offset longitudinally according to lateral wall 2a at sites such that when bolt 7 is engaged in keeper 9, one or the other of sensors 11, 12 faces one or the other of the two free ends of the end surface of curved wall 7a depending on whether bolt 7 occupies its position of locking or unlocking of lid 1 to frame 2.

Thus, when lid 1 is placed on support frame 2 with bolt 7 occupying its locking position as represented in FIG. 9, sensor 12 faces the upper end of the cylindrical sector of wall 7a for providing the information signal according to which lid 1 is effectively placed on frame 2 but not locked to the latter. This figure also shows that the lower end of the cylindrical sector of wall 7a does not face the other sensor 11.

When key 4 is maneuvered in the direction of locking of lid 1 to frame 2, bolt 7 rotates 90° from its upright position represented in FIG. 9 to its recumbent position represented in FIG. 10 in which it is immobilized in matching keeper 9. In this position, the end of the cylindrical sector of wall 7a farthest to the right in FIG. 10 faces sensor 11 that provides the information signal according to which lid 1 is locked to frame 2, with the other end of this sector no longer facing sensor 12.

As in the case of the first embodiment, sensors 11, 12 can be linked to the remote monitoring center in order to provide information on the status of lid 1 with respect to frame 2, namely whether lid 1 has been correctly locked to frame 2 once it has been placed on the latter.

Of course, key 4 can be maintained connected to lid 1 when the latter is removed from its frame as in the first embodiment.

The verification device according to the invention can be applied to any other type of lock for lid 1 placed on its support frame. Thus, this device can be used with a lock whose shaft is mounted so as to pivot in lid 1 perpendicularly to it and that can be kinematically connected to an arm as in the first embodiment or connected at its end to a curved wall in the form of a cylindrical sector as in the second embodiment in order to cooperate with two sensors that respectively provide two signals pertaining to the locking and unlocking of lid 1 to frame 2. The device of the invention can also be applied to a lock of the type with a simple bolt that slides in lid 1 also cooperating with two sensors for indication of the locking and unlocking of lid 1 to frame 2.

The verification device of the invention has an extremely simple and effective structure and does not require extensive transformation with regard to locking devices of known type, for example, known through European Patent No. 1 105 583.

1. A device for verification of locking or unlocking of a lock for immobilizing in a frame a lid for closing of the frame, comprising:
a lock connected to the lid and having a bolt that can be maneuvered by a key introduced through an opening in the lid to access the lock and cooperating with a matching keeper of the frame to bring the bolt into locking and unlocking positions of the lid with respect to the frame; and
detection means for detection of each of the locking and unlocking positions of the bolt providing a signal indicating whether the bolt occupies the locking or unlocking position.

2. The device according to claim 1, comprising an arm kinematically connected to the bolt of the lock and moving between two positions corresponding respectively to the locking and unlocking positions of the bolt.

3. The device according to claim 2, wherein
the arm is connected perpendicularly to a shaft carrying the bolt and mounted to pivot in the lid so the arm pivots below the lid essentially in a plane perpendicular to the lid between the two positions, and
the detection means includes two sensors connected to the frame at different locations, with a free end of the arm facing respective sensors at the locking and unlocking positions of the bolt, so that the sensor facing the arm provides the signal indication corresponding to the locking or unlocking position of the bolt.

4. The device according to claim 1, wherein the bolt of the lock is connected to a shaft pivoting in the lid, and having a free end including a wall curved over an angle of approximately 180°, and the detection means includes two sensors connected to the frame at different locations, with the free end of the wall of the bolt facing one of the two sensors when the bolt occupies the locking or unlocking position, so that the sensor facing the wall of the bolt provides the signal corresponding to the locking or unlocking position of the bolt.

5. The device according to to claim 1, wherein the detection means provides an information signal indicating that the lid is removed from the frame when the bolt is in the unlocking position.

6. The device according to claim 3, wherein each sensor is a proximity sensor or a contact sensor.

7. The device according to claim 3, wherein the sensors are housed in a cavity in a lateral wall of the frame containing the keeper and are arranged parallel to an upper edge of wall, below the end of the frame.

8. The device according to claim 3, wherein the sensors are housed in a cavity in a lateral wall of the frame containing the keeper and are arranged one above the other, offset longitudinally with respect to the lateral wall.

9. The device according to claim 1, wherein the key selectively adopts, with respect to the opening of the lid, a position locking the lid to the frame in which the key can be freely removed from the lid, and a position unlocking the lid in which the key is held captive in the opening of the lid.

10. The device according to claim 1, wherein the detection means is connected to a remote monitoring center for verifying status of the detection means.
